(19) United States
(12) Patent Application Publication
(10) Pub. No.: US 2025/0323771 A1
(43) Pub. Date: Oct. 16, 2025

(54) Apparatuses and Methods for a Radio Access Network

(71) Applicants: Gang XIONG, Portland, OR (US); Bishwarup MONDAL, San Ramon, CA (US); Dae Won LEE, Portland, OR (US); Sergey PANTELEEV, Leixlip, Co. Kildare (IE); Thushara HEWAVITHANA, Chandler, AZ (US)

(72) Inventors: Gang XIONG, Portland, OR (US); Bishwarup MONDAL, San Ramon, CA (US); Dae Won LEE, Portland, OR (US); Sergey PANTELEEV, Leixlip, Co. Kildare (IE); Thushara HEWAVITHANA, Chandler, AZ (US)

(21) Appl. No.: 19/090,484

(22) Filed: Mar. 26, 2025

Related U.S. Application Data
(60) Provisional application No. 63/632,951, filed on Apr. 11, 2024.

(51) Int. Cl. H04L 5/00; H04L 25/03; H04W 72/0446; H04W 72/1268

(52) U.S. Cl. CPC H04L 5/0051; H04L 25/03821; H04W 72/0446; H04W 72/1268

(57) ABSTRACT

An apparatus and method for supporting advanced receiver in an open radio access network. A distributed unit (DU) and a radio unit (RU) in a radio access network include an advanced receiver for supporting interference cancellation in the uplink transmissions. The DU provides to the RU demodulation reference signal (DMRS) configuration information and information regarding resource partition of scheduled resources for uplink transmissions from user equipments (UEs) in a slot. The RU receives uplink transmissions from UEs and sends equalized modulation symbols of at least one resource partition to the DU. The DU decodes the equalized modulation symbols, reconstructs modulation symbols for at least one resource partition based on the decoded modulation symbols, and sends the reconstructed modulation symbols to the RU. The RU performs interference cancellation on the modulation symbols of the uplink transmissions based on the reconstructed modulation symbols and sends interference-cancelled equalized modulation symbols to the DU.

### CROSS-REFERENCE TO RELATED APPLICATIONS

The present application claims a benefit of U.S. Provisional Application No. 63/632,951, filed on Apr. 11, 2024, the contents of which are incorporated herein by reference in its entirety.

### BACKGROUND

Open radio access network (O-RAN) is an approach to building mobile networks that promotes openness, interoperability, and flexibility by allowing different vendors' equipment and software to work together. Traditional radio access network solutions are usually proprietary. Open RAN, on the other hand, disaggregates the components of the network, allowing mobile operators to mix and match products from different vendors.

An O-RAN includes a radio unit (RU) and a distributed unit (DU). An O-RAN DU (O-DU) is a logical node that hosts radio link control (RLC), medium access control (MAC) and high-physical layer (PHY) based on a lower layer functional split. An O-RAN RU (O-RU) is a logical node that hosts low-PHY layer and radio frequency (RF) processing based on a lower layer functional split. It breaks down into the management plane (M-Plane) and the control user synchronization plane (CUS-Plane). In O-RAN, a fronthaul interface link connects an O-DU and an O-RU.

In O-RAN, the radio access network functionalities are split into the O-RAN components. The functional split defines where the processing responsibilities are split between the RU and DU. Split 7 is one of the options. Split 7.2 and split 7.3 refer to different ways of disaggregating the functions of the radio access network (RAN) between the RU and the DU. In split 7.2, the RU handles the RF functions and some PHY processing (such as beamforming), and the DU takes care of the rest of the PHY processing, including channel coding and decoding. In split 7.3, more PHY processing is performed in the RU than in split 7.2. The RU performs some additional PHY functions, such as forward error correction (FEC) encoding/decoding, and the DU handles the higher-layer PHY and MAC functions.

### BRIEF DESCRIPTION OF THE FIGURES

Some examples of apparatuses and/or methods will be described in the following by way of example only, and with reference to the accompanying figures, in which

FIG. 1 shows an example signal processing in a DU and an RU of an O-RAN in accordance with 7.2 split;

FIG. 2 is a block diagram of a radio access network including a DU and an RU;

FIG. 3 shows one example signal processing in a DU and an RU of an O-RAN that supports advanced receiver functionalities;

FIG. 4 shows another example signal processing of a DU and an RU of an O-RAN that supports advanced receiver functionalities;

FIG. 5 shows another example of signal processing of a DU and an RU of an O-RAN that supports advanced receiver;

FIG. 6 is a signaling diagram for message exchange between an RU and a DU for advanced receiver processing for the RAN architecture in FIGS. 3 and 4;

FIG. 7 is a signaling diagram for message exchange between an RU and a DU for advanced receiver processing for the RAN architecture in FIG. 5;

FIG. 8 is a flow diagram of an example method implemented in a DU for supporting advanced receiver in an O-RAN;

FIG. 9 is a flow diagram of an example method implemented in an RU for supporting advanced receiver in an O-RAN; and

FIG. 10 illustrates a base station or infrastructure equipment radio head in which the examples disclosed herein may be implemented.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A or B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

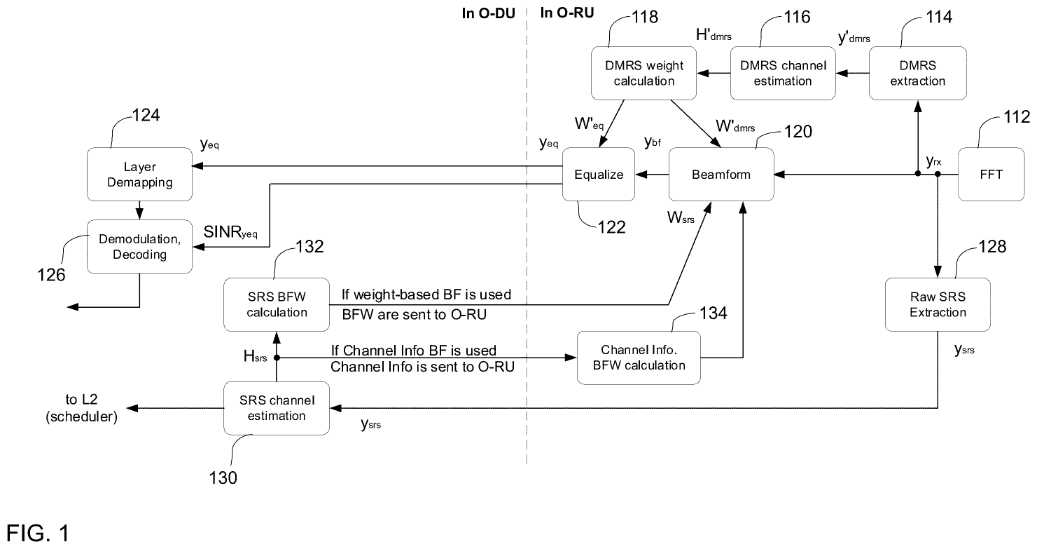

FIG. 1 shows an example signal processing in a DU and an RU of an O-RAN in accordance with 7.2 split. The O-RAN includes a DU (O-DU) and an RU (O-RU). FIG. 1 shows mainly baseband reception processing only for simplicity but the system may further include additional processing blocks for transmission processing, etc. During Uplink Performance Improvement (ULPI) study in O-RAN Working Group 4 (WG4), two classes of ULPI proposals were considered: Class A and Class B. FIG. 1 shows class A ULPI solution for O-RAN.

The RU includes multiple antennas (not shown in FIG. 1) to transmit and receive signals to and from user equipments (UEs) and may implement multiple-input multiple-output (MIMO), such as multi-user MIMO, massive-MIMO, etc. The RU performs fast Fourier transform (FFT) processing (block 112) on the uplink signals received from UEs as part of orthogonal frequency division multiplexing (OFDM) demodulation processing. In examples, the RU may extract demodulation reference signal (DMRS) from the OFDM symbol (block 114), perform channel estimation based on the extracted DMRS (block 116), and calculate weights and coefficients for beamforming and equalization (block 118). The DMRS is a known signal transmitted by the UE in the uplink. The DMRS may be used by the RU to estimate the wireless channel response (e.g., a channel matrix). The RU may calculate the beamforming weights and equalization coefficients based on the DMRS-based channel estimate and perform beamforming and equalization using the corresponding weights and coefficients determined based on the DMRS-based channel estimate.

The RU may perform beamforming by applying the beamforming weights to the received signal (e.g., multiplying complex weights to adjust phase and amplitude of received signals from multiple antennas). FIG. 1 shows beamforming processing (block 120) after FFT processing (block 112) such that the RU may perform beamforming per subcarrier in the frequency domain. Alternatively, the beamforming (block 120) may be performed before FFT processing (block 112) in the time domain.

After performing beamforming, the RU may then perform equalization based on the equalization coefficients (block 122). Equalization is applied to compensate for the effects of multipath fading, inter-symbol interference (ISI), frequency-selective fading, etc. The RU then sends the equalized modulation symbols (in-phase/quadrature (I/Q) symbols) to the DU via a fronthaul link. The RU and DU are connected using a wired fronthaul link. The DU then performs layer demapping (block 124) and demodulation and decoding processing (block 126) on the equalized I/Q modulation symbols received from the RU. The layer demapping 124 (spatial demapping) is the process of reconstructing the original modulated symbols from multiple received signals transmitted over different antennas. The decoded data bits output from the demodulation and decoding block 126 are sent for further processing.

The RU may extract sounding reference signal (SRS) and send the SRS signal to the DU via the fronthaul link (block 128). The DU then processes the SRS signal to estimate the channel (block 130) and determine beamforming weights based on the SRS-based channel estimate (block 132). Channel information-based beamforming or weight-based beamforming may be implemented. In case channel information-based beamforming is used, the RU sends SRS to the DU (block 128), and the DU estimates the channel state information (CSI) using the received SRS (block 130) and sends the CSI back to the RU. The RU then calculates beamforming weights based on the CSI (block 134) and applies the beamforming weights to uplink (UL) reception and downlink (DL) transmission (block 120). In case weight-based beamforming is used, the DU calculates beamforming weights based on the CSI and provides the beamforming weights to the RU (block 132), and the RU applies the beamforming weights to the UL reception and DL transmission (block 120).

In this example in FIG. 1, the functionalities of the O-RAN are split between the DU and the RU in accordance with split 7.2x. Alternatively, a different split scheme (e.g., split 7.2a/b, 7.3, etc.) may be used. In case of 7.3 split, the layer demapping function (block 124) may be moved from the DU to the RU.

In examples disclosed herein, systems and methods are disclosed for supporting advanced receivers in an O-RAN. To improve the performance of an uplink (e.g., a physical uplink shared channel (PUSCH)), an advanced receiver may be employed in the DU and the RU (i.e., additional functionalities may be included in the DU and the RU). The advanced receiver may include interference cancellation functionalities, such as hard successive interference cancellation (SIC), soft SIC, parallel interference cancellation (PIC), etc. In examples disclosed herein, to support advanced receivers in the O-RAN, the O-RAN fronthaul interface between the RU and the DU (e.g., split 7.2a/b, 7.2x, 7.3, etc.) is updated.

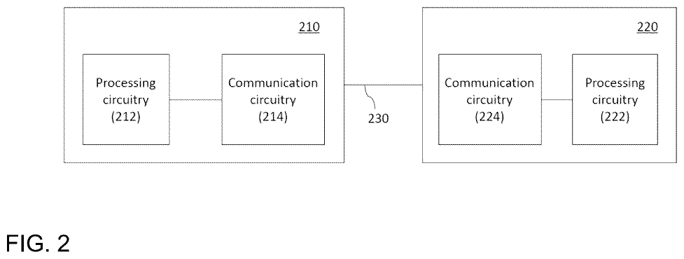

FIG. 2 is a block diagram of a radio access network including a DU 210 and an RU 220. The DU 210 includes a processing circuitry 212 and a communication circuitry 214. The communication circuitry 214 is configured to transmit and receive signals to and from the RU 220 via a fronthaul link 230. The processing circuitry 212 is configured to provide, to the RU 220 via the communication circuitry 214, DMRS configuration information and information regarding resource partition of scheduled resources for uplink transmissions from one or more UEs in a slot. In examples, the DMRS configuration information may include at least one of DMRS port number, DMRS configuration type, DMRS symbol positions, or indication of whether transform precoding is enabled or disabled. A resource partition comprises a set of layers and a set of PRBs common across the set of layers. The resource partition may be in specific time/frequency resources of the OFDM time/frequency resource grid and may also be specific spatial streams or spatial layers. The RU 220 receives uplink transmissions from one or more UEs and sends equalized modulation symbols of the uplink transmissions to the DU 210. The processing circuitry 212 is configured to receive the equalized modulation symbols of at least one resource partition for the uplink transmissions from the RU 220. The processing circuitry 212 is further configured to demodulate and decode the equalized modulation symbols and reconstruct modulation symbols for at least one resource partition for the uplink transmissions based on the decoded modulation symbols. The processing circuitry 212 is further configured to send the reconstructed modulation symbols to the RU 220 for interference cancellation, and receive interference-cancelled equalized modulation symbols of at least one other resource partition for the uplink transmissions from the RU 220.

In some examples, the processing circuitry 212 may be configured to send, to the RU 220, at least one of interference cancellation mode of operation information or information used for DMRS-based channel estimation. The interference cancellation mode of operation information may include at least one of the number of iterations for the interference cancellation in a slot, an interference cancellation option including soft-symbol cancellation or hard-symbol cancellation, or a resource partition that corresponds to a successfully decoded codeword. The information used for DMRS-based channel estimation may include at least one of mapping physical resource blocks and layers to UEs, or UE specific parameters of time-offset, frequency-offset, delay spread, and/or Doppler spread.

In some examples, the processing circuitry 212 may be configured to receive, from the RU 220, at least one of interference cancellation capability of the RU 220, or UE-specific parameters of time-offset, frequency-offset, delay spread, and/or Doppler spread. In some examples, the processing circuitry 212 may be configured to send the reconstructed modulation symbols to the RU 220 for interference cancellation and receive interference-cancelled equalized modulation symbols from the RU 220 in multiple iterations.

The RU 220 includes a processing circuitry 222 and a communication circuitry 224. The communication circuitry 224 is configured to transmit and receive signals to and from the DU 210 via the fronthaul link 230. The processing circuitry 222 is configured to perform advanced receiver functionalities for interference cancellation on the uplink transmissions from one or more UEs. The processing circuitry 222 is configured to receive, from the DU 210 via the communication circuitry 224, DMRS configuration information and information regarding resource partition of scheduled resources for uplink transmissions from at least one UE in a slot. In examples, the DMRS configuration information may include at least one of DMRS port number, DMRS configuration type, DMRS symbol positions, or indication of whether transform precoding is enabled or disabled. A resource partition comprises a set of layers and a set of PRBs common across the set of layers. The processing circuitry 222 is configured to receive uplink transmissions from one or more UEs, process the uplink transmissions, and send equalized modulation symbols of at least one resource partition of the uplink transmissions to the DU 210. The processing circuitry 222 is configured to receive reconstructed modulation symbols for at least one resource partition for the uplink transmissions from the DU 210, perform interference cancellation on the modulation symbols of the uplink transmissions based on the reconstructed modulation symbols, and send interference-cancelled equalized modulation symbols of at least one other resource partition for the uplink transmissions to the DU 210.

In some examples, the processing circuitry 222 may be configured to receive from the DU 210 at least one of interference cancellation mode of operation information, or information used for DMRS-based channel estimation. The interference cancellation mode of operation information may include at least one of the number of iterations for the interference cancellation in a slot, an interference cancellation option including soft-symbol cancellation or hard-symbol cancellation, or a resource partition that corresponds to a codeword successfully decoded by the DU 210. The information used for DMRS-based channel estimation may include at least one of mapping physical resource blocks and layers to UEs, or UE specific parameters of time-offset, frequency-offset, delay spread, and/or Doppler spread.

In some examples, the processing circuitry 222 may be configured to send to the DU 210 at least one of interference cancellation capability of the RU 220 unit, or UE-specific parameters of time-offset, frequency-offset, delay spread, and/or Doppler spread. The processing circuitry 222 may be configured to receive the reconstructed modulation symbols from the DU 210 for interference cancellation and send interference-cancelled equalized modulation symbols of the uplink transmissions to the DU 210 in multiple iterations.

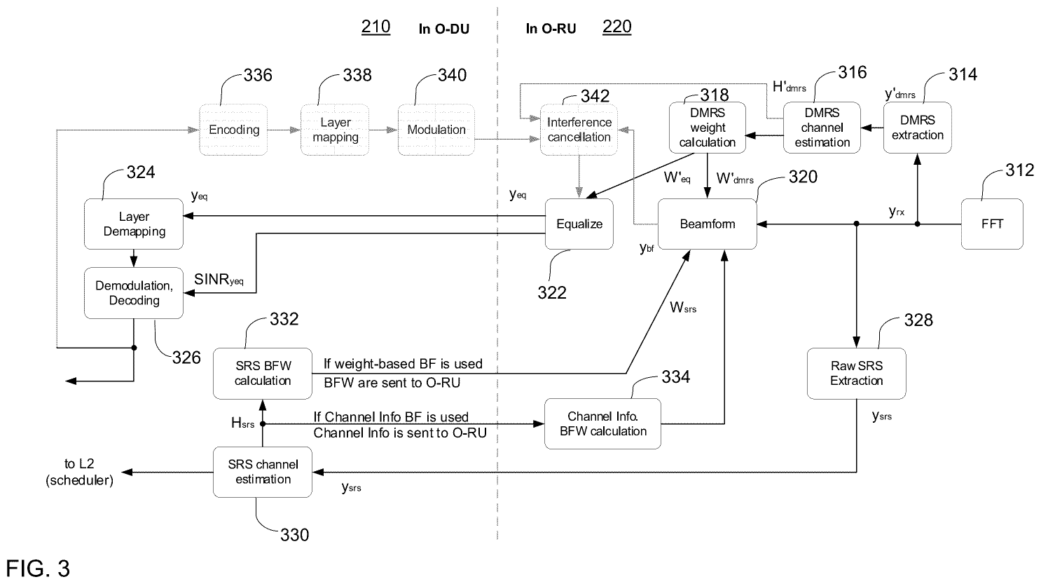

FIG. 3 shows one example signal processing in a DU (O-DU) 210 and an RU (O-RU) 220 of an O-RAN that supports advanced receiver functionalities. In this example, the functionalities of the DU 210 and the RU 220 are split in accordance with 7.2x split. Alternatively, a different split scheme (e.g., split 7.2a/b, 7.3, etc.) may be used. FIG. 3 shows mainly baseband reception processing only for simplicity but the system may further include additional processing blocks for transmission processing, etc.

The RU 220 includes multiple antennas (now shown in FIG. 3) to transmit and receive signals to and from UEs and may implement MIMO, such as single-user MIMO, multi-user MIMO, massive-MIMO, etc. The RU 220 performs fast FFT processing (block 312) on the uplink signals received from one or more UEs as part of OFDM demodulation processing. In examples, the RU 220 may extract DMRS from the OFDM symbol (block 314), perform channel estimation based on the extracted DMRS (block 316), and calculate weights and coefficients for beamforming and equalization (block 318). The DMRS is a known signal transmitted by a UE in the uplink. The DMRS may be used by the RU 220 to estimate the wireless channel response (e.g., a channel matrix). The RU 220 may calculate the beamforming weights and equalization coefficients based on the DMRS-based channel estimate and perform beamforming and equalization using the corresponding weights and coefficients determined based on the DMRS-based channel estimate.

The RU 220 may perform beamforming by applying the beamforming weights to the received signal (e.g., multiplying complex weights to adjust phase and amplitude of received signals from multiple antennas). FIG. 3 shows beamforming processing (block 320) after FFT processing (block 312) such that the RU 220 may perform beamforming per subcarrier in the frequency domain. Alternatively, the beamforming (block 320) may be performed before FFT processing (block 312) in the time domain.

After performing beamforming, the RU 220 may then perform equalization based on the equalization coefficients (block 322). Equalization is applied to compensate for the effects of multipath fading, ISI, frequency-selective fading, etc. The RU 220 then sends the equalized modulation symbols (I/Q symbols) to the DU 210. The DU 210 performs layer demapping (block 324) and demodulation and decoding processing (block 326) on the equalized I/Q modulation symbols received from the RU 220. The decoded data bits output from the demodulation and decoding block 326 are sent for further processing.

The RU 220 may extract SRS and send the SRS signal to the DU 210 (block 328). The DU 210 then processes the SRS signal to estimate the channel (block 330) and determine beamforming weights based on the SRS-based channel estimate (block 332). Channel information-based beamforming or weight-based beamforming may be implemented. In case channel information-based beamforming is used, the RU 220 sends SRS to the DU 210 (block 328), and the DU 210 estimates the CSI using the received SRS (block 330) and sends the CSI back to the RU 220. The RU 220 then calculates beamforming weights based on the CSI (block 334) and applies the beamforming weights to UL reception and DL transmission (block 320). In case weight-based beamforming is used, the DU 210 calculates beamforming weights based on the CSI and provides the beamforming weights to the RU 220 (block 332), and the RU 220 applies the beamforming weights to the UL reception and DL transmission (block 320).

In examples, the receivers of the DU 210 and the RU 220 include interference cancellation functionalities (e.g., SIC, PIC, etc.). The O-RAN may implement MIMO, where multiple signals are transmitted/received simultaneously using an array of antennas. MIMO, such as massive MIMO and multi-user MIMO, is a key technology in 5G and beyond using large arrays of antennas to serve multiple users simultaneously. While it offers significant improvements in spectral efficiency, it also introduces interference challenges, mainly due to intra-cell interference and inter-cell interference. Intra-cell interference occurs when multiple users within the same cell share the same time-frequency resources. Even though MIMO uses spatial multiplexing to serve multiple UEs, imperfect beamforming can cause interference between users due to pilot contamination when multiple users share the same pilot sequences, channel estimation errors causing imperfect beamforming, correlation among antennas, etc. Inter-cell interference may occur due to frequency reuse across multiple cells. Beam leakage from one cell can interfere with users in another cell. In areas where base stations are closer together, inter-cell interference can be significant. In examples disclosed herein, the receivers of the DU and RU implement interference cancellation, such as SIC, PIC, etc.

SIC is a step-by-step sequential process where signals are decoded one at a time while removing the effect of already decoded signals before processing the next one. The O-RAN receives a signal containing multiple superimposed transmissions from multiple UEs, detects and decodes the strongest signal (e.g., the one with the highest signal-to-noise ratio (SNR)), reconstructs the detected signal using modulation and coding scheme, and subtracts the reconstructed signal from the received signal to eliminate its interference. This process is repeated for the next strongest signal until all signals are decoded.

PIC processes multiple signals simultaneously, estimating and canceling interference in parallel for all users. The O-RAN receives a signal containing multiple superimposed transmissions from multiple UEs, simultaneously estimates all transmitted signals based on initial channel estimates, reconstructs all signals and computes their interference contributions, and subtracts interference estimates from the received signal.

Referring to FIG. 3, the DU 220 may include an encoding block 336, a layer mapping block 338, and a modulation block 340, and the RU 220 may include an interference cancellation block 342. In case of 7.2x split, the DU 210 performs layer demapping (block 324) on the equalized I/Q modulation symbols received from the RU 220 and then performs demodulation and decoding processing (block 326). The modulation symbols are reconstructed by re-encoding the decoded information bits (i.e., the outputs from the demodulation/decoding block 326), and layer mapping (block 338) and modulating the layer-mapped re-encoded information bits (block 340). The DU 210 then sends the reconstructed modulation symbols to the RU 220 via the fronthaul link 130. The RU 220 then performs interference cancellation (e.g., SIC, PIC, etc.) (block 342) on the modulation symbols after beamforming based on the reconstructed modulation symbols received from the DU 210 and the estimated channel from DMRS.

An exemplary SIC operation is explained herein. In a scheduled slot, the following process may be performed for interference cancellation.

A DU 210 may provide DMRS configuration to the RU 220 and partition the scheduled resources (a set of layers and PRBs) in the slot based on resource allocation for UEs for uplink transmissions. One partition comprises resources allocated to one UE. In the PRBs where multiple UEs are allocated overlapping resources, the DU 210 may request the RU 220 to send the partitions with the highest probability of detection. In one example, the RU 220 may send the partitions for a UE or a layer or a codeword with highest signal-to-interference and noise ratio (SINR) to DU 210 for decoding.

The RU 220 receives uplink transmissions from one or more UEs and processes the uplink transmissions. The RU 220 then sends the equalized modulation symbols and associated SINRs for the requested resource partitions to the DU 210.

The DU 210 performs demodulation (e.g., log-likelihood ratio (LLR) calculations) and attempts decoding on the equalized modulation symbols received from the RU 220. After successful decoding, the decoded bits may be mapped to (soft) modulation symbols and passed to the RU 220. The RU 220 may use the mean and variance of the modulation symbols for the next iteration of interference cancellation and equalization. The RU 220 then sends to the DU 210 the equalized symbols and associated SINRs for another set of requested partitions.

In case of SIC, the DU 210 may reconstruct the modulation symbols for the strongest signal (e.g., the one with the highest SINR) using the same modulation and coding scheme, and the RU 220 may subtract the reconstructed signal from the received signal to eliminate its interference, and the DU 210 may demodulate and decode the residual signal after interference cancellation. This process may be repeated for the next strongest signal component until all signal components are decoded.

An exemplary PIC operation will be explained herein. In a scheduled slot, the following process may be performed for interference cancellation.

A DU 210 may provide DMRS configuration to the RU 220 and partition the scheduled resources (a set of layers and PRBs) in a slot based on resource allocation for UEs for uplink transmissions. One partition comprises of all the resources allocated to UEs in the slot.

The RU 220 receives uplink transmissions from one or more UEs and processes the uplink transmissions. The RU 220 then sends the equalized modulation symbols and associated SINRs for the scheduled resources of the entire slot to the DU 210.

The DU 210 performs demodulation (e.g., LLR calculations) and attempts decoding for a UE(s). After successful decoding, the decoded bits are mapped to (soft) modulation symbols and passed to the RU. The RU 220 may use the mean and variance of the modulation symbols for the next iteration of interference cancellation and equalization. The RU 220 then sends to the DU 210 the equalized symbols and associated SINRs for the scheduled resources for the entire slot.

In case of PIC, the DU 210 may reconstruct all signals, and the RU 220 may compute their interference contributions and subtract interference estimates from the received signal. After interference cancellation, the RU 220 may then perform equalization on the interference-cancelled modulation symbols and then sends the interference-cancelled equalized modulation symbols to the DU 210.

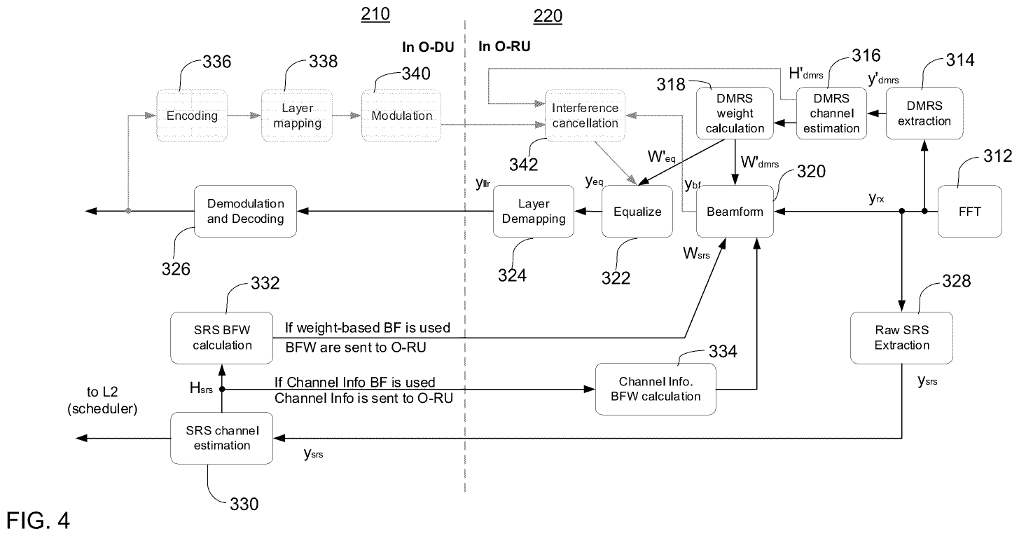

FIG. 4 shows another example signal processing of a DU (O-DU) 210 and an RU (O-RU) 220 of an O-RAN that supports advanced receiver functionalities. In this example, the functionalities of the DU 210 and the RU 220 are split in accordance with 7.3 split. The structure of the DU 210 and the RU 220 of the O-RAN in FIG. 4 is basically the same as the one shown in FIG. 3 except that the layer demapping function 324 is moved from the DU 210 to the RU 220.

In the above examples shown in FIGS. 3 and 4, in a scheduled slot, the DU 210 may send certain information to the RU 220 via the fronthaul link 230 for configuration and implementation of the interference cancellation in the O-RAN. The information sent from the DU 210 to the RU 220 may include one or more of the following: information needed for the RU 220 to determine an interference cancellation mode of operation, DMRS configuration and mapping of DMRS to layers and resource elements (REs), assistance information for DMRS channel estimation, a set of partitions of the scheduled layers and physical resource blocks (PRBs) in the slot, or a set of modulation symbols (mean and variance) corresponding to each partition of scheduled layers and PRBs in the slot.

The information needed for the RU to determine an interference cancellation mode of operation comprises the number of iterations for interference cancellation between the DU 210 and the RU 220 for a slot and certain configurable options such as soft-symbol cancellation or hard-symbol cancellation. The information needed for the RU 220 to determine an interference cancellation mode of operation may not change from slot to slot and may not be indicated in a slot. This information may include layers or resources that correspond to already successfully decoded information stream (codewords). The successfully decoded information stream indication could be used by the RU 220 to not send equalized complex I/Q data for the successfully decoded resources (as they have already been processed by the DU). This information could be part of the requested partition information from the RU.

The DMRS configuration and mapping of DMRS to layers and REs are used by the RU 220 to generate DMRS waveform and map it to all the applicable scheduled REs in the slot. This information comprises DMRS port number (\tilde{p} as in 3GPP specification 38.211), DMRS configuration type, DMRS symbol positions and whether transform precoding is enabled or disabled. This information is provided for all the scheduled PRBs and layers in the slot.

The assistance information for DMRS channel estimation is beneficial for the RU 220 to perform DMRS channel estimation for all the scheduled PRBs and layers in the slot. This information comprises mapping PRBs and layers to UEs and UE specific parameters of time-offset, frequency-offset, delay spread, and Doppler spread. The RU at 220 may perform DMRS channel estimation based on the UE specific parameters of time-offset, frequency-offset, delay spread, and Doppler spread received from the DU at 210.

The DU 210 may specify the set of resource partitions of the scheduled layers and PRBs in the slot to be reported by the RU 220. The requested resource partition may be resources in specific time/frequency resources of the OFDM time/frequency resource grid and it may also be specific spatial streams or spatial layers. The RU 220 may send only the equalized complex I/Q data and SINR values for the requested resource partitions of the scheduled layers and PRBs. The information for a resource partition comprises a set of layers and a set of PRBs common across the set of layers. The resources (i.e., a set of layers and a set of PRBs) for a partition is non-overlapping. The total resources across all partitions is equal to the total scheduled resources in the slot. As an example, when UE1 and UE2 are scheduled in the slot with fully overlapping set of PRBs, partition 1 may correspond to the resources for UE1 and partition 2 may correspond to the resources for UE2. As another example, when UE1 is scheduled with two codewords in the slot, partition 1 may correspond to the resources for codeword 1 and partition 2 may correspond to the resources for codeword 2. It is also possible that there is only one applicable partition that is the entire scheduled resources (set of layers and set of PRBs) for the slot. This may be the case for PIC.

The set of reconstructed modulation symbols (e.g., mean and variance) corresponding to one or more resource partitions of scheduled layers and PRBs in the slot are sent from the DU 210 to the RU 220. In case of hard-cancellation, variance may be fixed to 0 and modulation symbol may be conveyed by modulation compression (without I/Q data). In case of soft-cancellation, soft symbols are conveyed as I/Q data.

Further, in a scheduled slot, the RU 220 may send one or more of the following pieces of information to the DU 210 via the fronthaul link 230: interference cancellation capability advertisement, equalized I/Q data (modulation symbols) and SINR corresponding to the requested resource partitions, or assistance information for the DU 210.

The interference cancellation capability advertisement comprises information regarding capability of the RU 210, for example as to the number of iterations between the DU 210 and the RU 220 for a slot and certain configurable options such as soft-symbol or hard-symbol cancellation. The DU 210 and the RU 220 may set up for interference cancellation based on the interference cancellation capability information of the RU 220.

The RU 220 may send equalized I/Q data and associated SINR values to the DU 210 only for requested resource partitions. The requested partition information may be resources in specific time/frequency resources of the OFDM time/frequency resource grid and it may also be specific spatial streams or spatial layers.

The assistance information for the DU 210 is beneficial for the DU 210 for processing the received modulation symbols without access to the DMRS. The assistance information may include UE specific parameters of time-offset, frequency-offset, delay spread, and Doppler spread. The DU at 210 may perform SRS-based channel estimation based on UE specific parameters of time-offset, frequency-offset, delay spread, and Doppler spread received from the RU at 220.

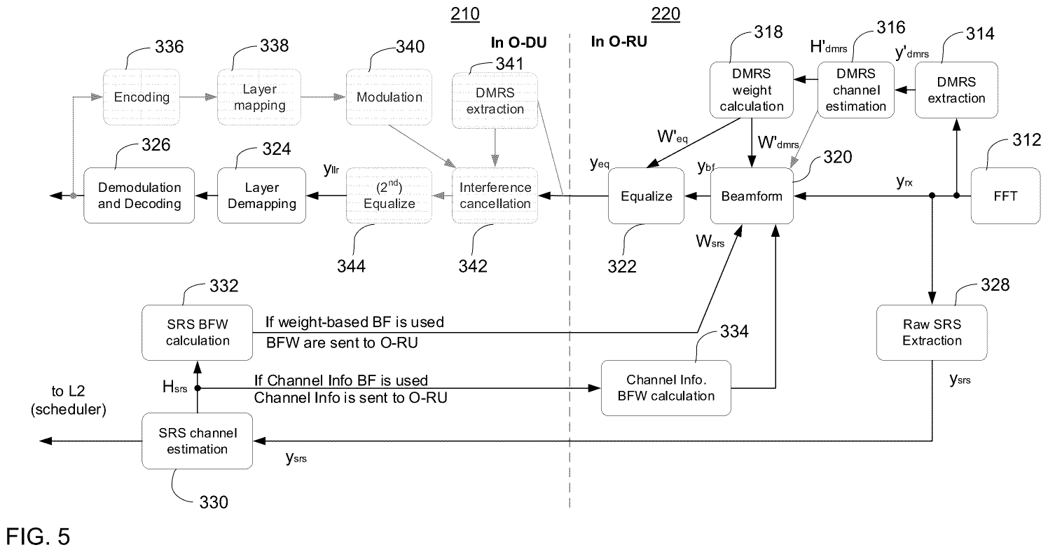

FIG. 5 shows another example of signal processing of a DU (O-DU) 210 and an RU (O-RU) 220 of an O-RAN that supports advanced receiver. In this example, the functionalities of the DU 210 and the RU 220 are split in accordance with 7.2x split. The structure of the DU 210 and RU 220 of the O-RAN in FIG. 5 is basically the same as the ones shown in FIGS. 3 and 4. Therefore, the same functional blocks will not be explained for simplicity.

In this example, the DU 210 includes interference cancellation functionalities (e.g., SIC or PIC). The DU 210 includes an encoding block 336, a layer mapping block 338, a modulation block 340, a DMRS extraction block 341, an interference cancellation block 342, and an equalization block 344. The DU 210 performs layer demapping (block 324) on the equalized I/Q symbols received from the RU 220 and then performs demodulation and decoding processing (lock 326). The modulation symbols are then reconstructed by the encoding block 336, the layer mapping block 338, and the modulation block 340 for interference cancellation (SIC or PIC). The encoding block 336 encodes the decoded information bits. The layer mapping block 338 performs layer mapping on the encoded information bits from the encoding block 336. The modulation block 340 processes the encoded information bits after layer mapping to generate the modulated symbols based on the modulation scheme and order. The DMRS extraction block 341 may extract DMRS from the equalized modulated symbols received from the RU 220 and generate channel coefficients based on the extracted DMRS. Alternatively, a channel estimate may be generated by the RU 220 based on DMRS and provided to the DU 210. The output of the DMRS extraction block 341 may be channel coefficients that could be used by the interference cancellation block 342 and the DU-side equalization block 344. The interference cancellation block 342 in the DU 210 performs interference cancellation on the received symbols from the RU 220 based on the reconstructed modulated symbols and the estimated channel from the DMRS extraction block 341. The equalization block 344 in the DU 210 may then perform equalization on the received symbols after interference cancellation.

In this example shown in FIG. 5, in a scheduled slot, the DU 210 may send certain information to the RU 220 via the fronthaul link 230 for configuration and implementation of the interference cancellation in the O-RAN. The information sent from the DU 210 to the RU 220 may include one or more of the following: DMRS configuration and mapping of DMRS to layers and REs, assistance information for DMRS channel estimation, or DMRS resource processing method.

The DMRS configuration and mapping of DMRS to layers and REs are used by the RU 220 to generate DMRS waveform and map it to all the applicable scheduled REs in the slot. This information comprises DMRS port number (\tilde{p} as in 3GPP specification 38.211), DMRS configuration type, DMRS symbol positions and whether transform precoding is enabled or disabled. This information is provided for all the scheduled PRBs and layers in the slot.

The assistance information for DMRS channel estimation is beneficial for the RU 220 to perform DMRS channel estimation for all the scheduled PRBs and layers in the slot. This information comprises mapping PRBs and layers to UEs and UE specific parameters of time-offset, frequency-offset, delay spread, and Doppler spread.

The DMRS resource processing method information is provided to indicate to the RU 220 how the DMRS resource should be processed before being provided to the DU 210. One example of DMRS resource processing is to apply similar (or same) equalization to data and DMRS resources. For example, if equalization filter weight has been applied to data resources near the DMRS resources, the same equalization filter weight may be applied to the DMRS resources and then passed through the fronthaul link to the DU 210. Another processing method may be the RU 220 to directly perform channel estimation based on DMRS resources and pass the estimated channel coefficients for the DMRS resources to the DU 210.

In a scheduled slot, one or more of the following pieces of information may be transferred from the RU 220 to the DU 210: equalized I/Q data and SINR corresponding to the requested resource partitions, equalized I/Q DMRS resources and SINR corresponding to the requested partitions, channel coefficients of corresponding DMRS resources and optionally SINR corresponding to the requested partitions, or assistance information for the DU 210.

The RU 220 may send equalized I/Q data and associated SINR values to the DU 210 only for the requested partitions. The RU 220 may send equalized I/Q symbols of DMRS resources and associated SINR values to the DU 210 only for requested partitions. Alternatively, the RU 220 may send estimated channel coefficients (in I/Q symbols) that correspond to the DMRS resources and optionally associated SINR values to the DU 210 only for the requested partitions. The assistance information for DU 210 is beneficial for the DU 210 without access to DMRS. This includes UE specific parameters of time-offset, frequency-offset, delay spread, and Doppler spread.

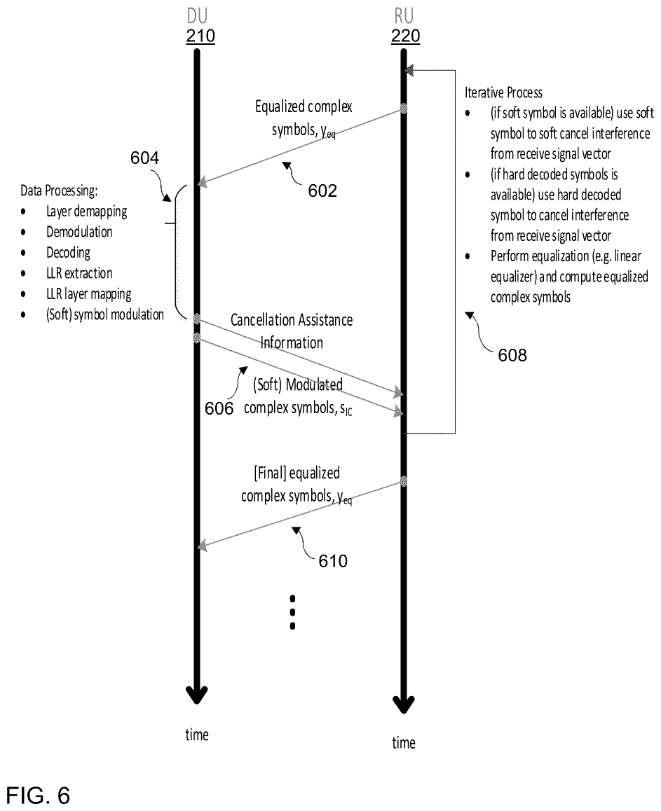

FIG. 6 is a signaling diagram for message exchange between an RU 220 and a DU 210 for advanced receiver processing for the RAN architecture in FIGS. 3 and 4. It should be noted that in FIG. 6, not all messages required for receive signal processing between the DU 210 and the RU 220 are shown and only the messages related to advanced receiver processing are illustrated.

The RU 220 receives and processes a signal from UEs and sends equalized complex modulation symbols to the DU 210 (602). The DU 210 processes the received modulation symbols (604). This processing may include layer demapping, demodulation, decoding, LLR extraction, LLR layer mapping, and (soft) symbol modulation. The DU 210 sends back the reconstructed modulated complex symbols and optionally cancellation assistance information to the RU (606). The cancellation assistance information may include the successfully decoded layer and resource information. The RU 220 then performs interference cancellation (608). If soft symbols are available, soft symbols may be used to soft cancel the interference from the received signal vector. If hard decoded symbols are available, hard decoded symbols may be used to cancel the interference from the received signal vector. The RU 220 may then perform equalization (e.g., using a linear or non-linear equalizer) and compute equalized complex symbols. The steps 602-608 may be repeated multiple times. In the iterative process, where the RU 220 sends the equalized complex symbols to the DU 210, the RU 220 may omit transmission of equalized complex symbols for layers and resources that have been indicated as successfully decoded by the DU 210. After completion of the last iteration, the RU 220 sends the final equalized complex symbols to the DU 210 (610).

The iterative nature of the advanced receiver for the RAN architecture in FIGS. 3 and 4 implies tight requirements on the processing delay and message exchange delay on the RU and DU sides. In order to manage these additional delays and fronthaul throughput implications, the RU 220 and the DU 210 may exchange processing time capabilities for one or more steps performed as part of one iteration. The processing time capabilities may be used to configure the receive processing for a particular number of iterations which are feasible to be performed with the exchange of the information between the DU 210 and the RU 220.

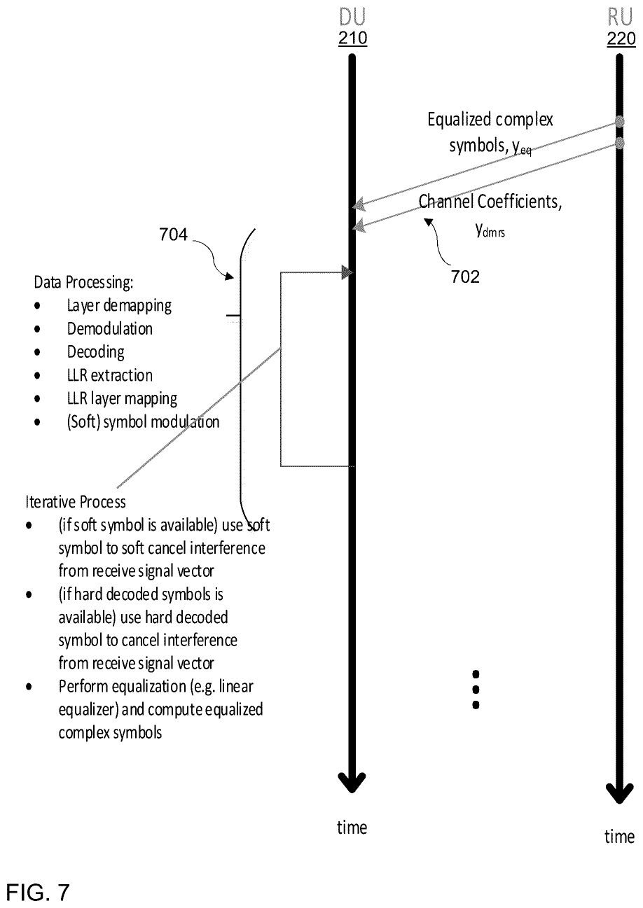

FIG. 7 is a signaling diagram for message exchange between an RU 220 and a DU 210 for advanced receiver processing for the RAN architecture in FIG. 5. It should be noted that in FIG. 7, not all messages required for receive signal processing between the DU and the RU are shown and only the messages related to advanced receiver processing are illustrated.

The DU 210 provides DMRS configuration to the RU 220 and partitions the scheduled resources (set of layers and PRBs) in a slot based on resource allocation for uplink transmissions for UEs. One partition comprises of resources allocated to one UE.

The RU 220 receives and processes uplink transmissions from UEs and sends the equalized modulation symbols and associated SINRs for the requested partitions to the DU 210 (702). For example, the RU 220 may send the equalized DMRS resources along with the equalized data resources. Alternatively, the RU 220 may send estimated channel coefficients of the DMRS resources along with equalized data resources.

The DU 210 then processes the received equalized modulation symbols (704). This processing includes layer demapping, demodulation, decoding, LLR extraction, LLR layer mapping, and (soft) symbol modulation. The DU 210 performs LLR calculations and attempts decoding using advanced receiver techniques such as interference cancellation. In performing interference cancellation, if soft symbols are available, soft symbols may be used to soft cancel the interference from the received signal vector, and if hard decoded symbols are available, hard decoded symbols may be used to cancel the interference from the received signal vector. The interference cancellation may be performed iteratively.

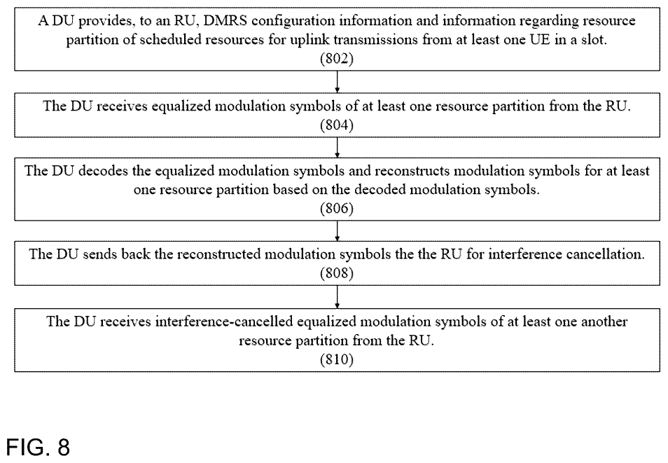

FIG. 8 is a flow diagram of an example method implemented in a DU 210 for supporting advanced receiver in an O-RAN. A DU 210 provides, to an RU 220, DMRS configuration information and information regarding resource partition of scheduled resources for uplink transmissions from at least one user equipment in a slot (802). The DU 210 receives equalized modulation symbols of at least one resource partition for the uplink transmissions from the RU 220 (804). The DU 210 demodulates and decodes the equalized modulation symbols and reconstructs modulation symbols for at least one resource partition for the uplink transmissions based on the decoded modulation symbols (806). The DU 210 sends the reconstructed modulation symbols to the RU 220 for interference cancellation (808). The DU 210 receives interference-cancelled equalized modulation symbols of at least one other resource partition for the uplink transmissions from the RU (810).

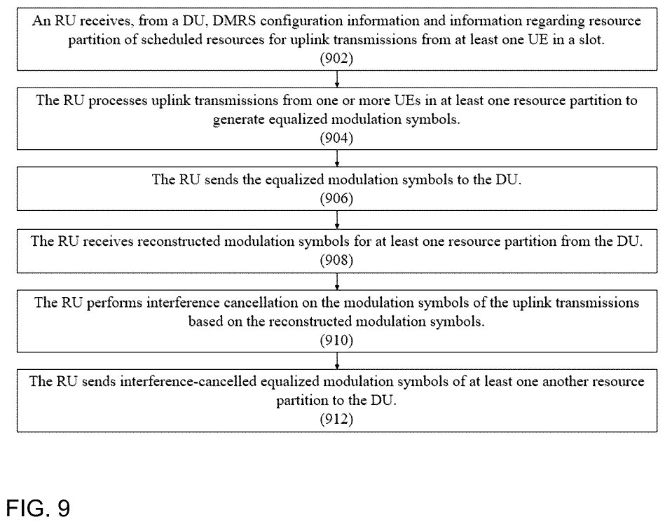

FIG. 9 is a flow diagram of an example method implemented in an RU 220 for supporting advanced receiver in an O-RAN. An RU 220 receives, from a DU 210, DMRS configuration information and information regarding resource partition of scheduled resources for uplink transmissions from at least one UE in a slot (902). The RU 220 receives and processes uplink transmissions from one or more UEs in at least one resource partition for the uplink transmissions to generate equalized modulation symbols (904). The RU 220 sends the equalized modulation symbols to the DU 210 (906). The RU 220 receives reconstructed modulation symbols for at least one resource partition for the uplink transmissions from the DU 210 (908). The RU 220 performs interference cancellation on the modulation symbols of the uplink transmissions based on the reconstructed modulation symbols (910). The RU 220 then sends interference-cancelled equalized modulation symbols of at least one other resource partition for the uplink transmissions to the DU 210 (912).

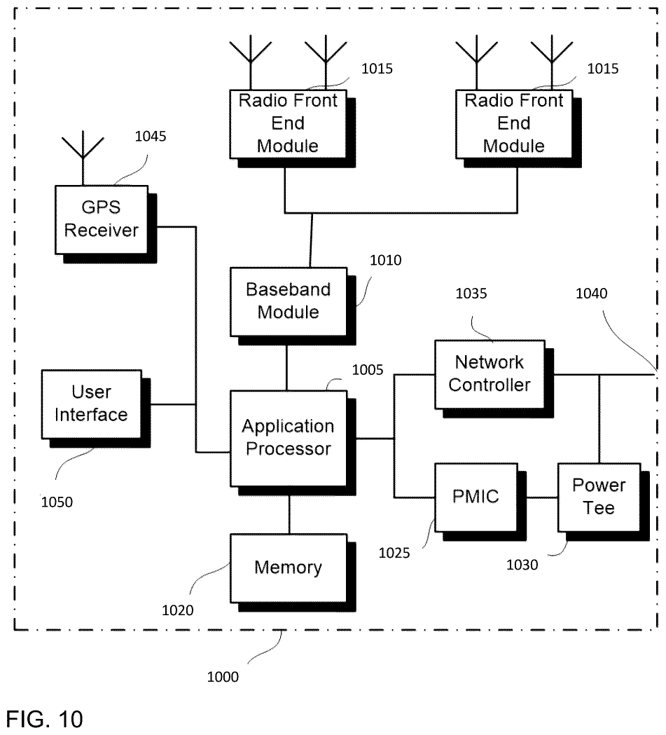

FIG. 10 illustrates a base station or infrastructure equipment radio head 1000 in which the examples disclosed herein may be implemented. For example, the examples disclosed herein may be implemented in the radio front-end module 1015, in the baseband module 1010, etc. The base station radio head 1000 may include one or more of application processor 1005, baseband modules 1010, one or more radio front end modules 1015, memory 1020, power management circuitry 1025, power tee circuitry 1030, network controller 1035, network interface connector 1040, satellite navigation receiver module 1045, and user interface 1050.

In some aspects, application processor 1005 may include one or more CPU cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 1010 may be implemented, for example, as a solder-down substrate including one or more integrated circuits, a single packaged integrated circuit soldered to a main circuit board or a multi-chip module containing two or more integrated circuits.

In some aspects, memory 1020 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto resistive random access memory (MRAM) and/or a three-dimensional crosspoint memory. Memory 1020 may be implemented as one or more of solder down packaged integrated circuits, socketed memory modules and plug-in memory cards.

In some aspects, power management integrated circuitry 1025 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 1030 may provide for electrical power drawn from a network cable to provide both power supply and data connectivity to the base station radio head 1000 using a single cable.

In some aspects, network controller 1035 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 1045 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 1045 may provide data to application processor 1005 which may include one or more of position data or time data. Application processor 1005 may use time data to synchronize operations with other radio base stations.

In some aspects, user interface 1050 may include one or more of physical or virtual buttons, such as a reset button, one or more indicators such as light emitting diodes (LEDs) and a display screen.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to an apparatus for a radio access network. The apparatus may include a communication circuitry configured to transmit and receive a signal to and from an RU, and a processing circuitry. The processing circuitry may be configured to provide, to the RU via the communication circuitry, DMRS configuration information and information regarding resource partition of scheduled resources for uplink transmissions from one or more UEs in a slot, receive equalized modulation symbols of at least one resource partition for the uplink transmissions from the radio unit, decode the equalized modulation symbols and reconstruct modulation symbols for at least one resource partition based on the decoded modulation symbols, send the reconstructed modulation symbols to the radio unit for interference cancellation, and receive interference-cancelled equalized modulation symbols of at least one other resource partition for the uplink transmissions from the radio unit.

Another example, (e.g., example 2) relates to a previously described example (e.g., example 1), wherein the processing circuitry may be configured to send, to the RU, at least one of interference cancellation mode of operation information or information used for DMRS-based channel estimation.

Another example, (e.g., example 3) relates to a previously described example (e.g., example 2), wherein the interference cancellation mode of operation information may include at least one of the number of iterations for the interference cancellation in a slot, an interference cancellation option including soft-symbol cancellation or hard-symbol cancellation, or a resource partition that corresponds to a successfully decoded codeword.

Another example, (e.g., example 4) relates to a previously described example (e.g., any one of examples 2-3), wherein the information used for DMRS-based channel estimation includes at least one of mapping physical resource blocks and layers to UEs, or UE specific parameters of time-offset, frequency-offset, delay spread, and/or Doppler spread.

Another example, (e.g., example 5) relates to a previously described example (e.g., any one of examples 1-4), wherein the DMRS configuration information includes at least one of DMRS port number, DMRS configuration type, DMRS symbol positions, or indication of whether transform precoding is enabled or disabled.

Another example, (e.g., example 6) relates to a previously described example (e.g., any one of examples 1-5), wherein the processing circuitry is configured to receive, from the radio unit, at least one of interference cancellation capability of the radio unit, or UE-specific parameters of time-offset, frequency-offset, delay spread, and/or Doppler spread.

Another example, (e.g., example 7) relates to a previously described example (e.g., any one of examples 1-6), wherein the processing circuitry is configured to send the reconstructed modulation symbols to the radio unit for interference cancellation and receive interference-cancelled equalized modulation symbols from the radio unit in multiple iterations.

Another example, (e.g., example 8) relates to an apparatus for a radio access network. The apparatus may include a communication circuitry configured to transmit and receive a signal to and from a DU and a processing circuitry. The processing circuitry may be configured to receive, from the DU via the communication circuitry, DMRS configuration information and information regarding resource partition of scheduled resources for uplink transmissions from at least one UE in a slot, receive uplink transmissions from one or more UEs, send equalized modulation symbols of at least one resource partition of the uplink transmissions to the distributed unit, receive reconstructed modulation symbols for at least one resource partition for the uplink transmissions from the distributed unit, perform interference cancellation on the equalized modulation symbols of the uplink transmissions based on the reconstructed modulation symbols, and send interference-cancelled equalized modulation symbols of at least one other resource partition for the uplink transmissions to the distributed unit.

Another example, (e.g., example 9) relates to a previously described example (e.g., example 8), wherein the processing circuitry may be configured to receive from the distributed unit at least one of interference cancellation mode of operation information, or information used for DMRS-based channel estimation.

Another example, (e.g., example 10) relates to a previously described example (e.g., example 9), wherein the interference cancellation mode of operation information includes at least one of the number of iterations for the interference cancellation in a slot, an interference cancellation option including soft-symbol cancellation or hard-symbol cancellation, or a resource partition that corresponds to a codeword successfully decoded by the distributed unit.

Another example, (e.g., example 11) relates to a previously described example (e.g., any one of examples 9-10), wherein the information used for DMRS-based channel estimation includes at least one of mapping physical resource blocks and layers to UEs, or UE specific parameters of time-offset, frequency-offset, delay spread, and/or Doppler spread.

Another example, (e.g., example 12) relates to a previously described example (e.g., any one of examples 8-11), wherein the DMRS configuration information includes at least one of DMRS port number, DMRS configuration type, DMRS symbol positions, or indication of whether transform precoding is enabled or disabled.

Another example, (e.g., example 13) relates to a previously described example (e.g., any one of examples 8-12), wherein the processing circuitry is configured to send to the distributed unit at least one of interference cancellation capability of the apparatus, or UE-specific parameters of time-offset, frequency-offset, delay spread, and/or Doppler spread.

Another example, (e.g., example 14) relates to a previously described example (e.g., any one of examples 8-13), wherein the processing circuitry is configured to receive the reconstructed modulation symbols from the distributed unit for interference cancellation and send interference-cancelled equalized modulation symbols of the uplink transmissions to the distributed unit in multiple iterations.

Another example (e.g., example 15) relates to a method for a radio access network. The method may include providing, to an RU, DMRS configuration information and information regarding resource partition of scheduled resources for uplink transmissions from at least one UE in a slot, receiving equalized modulation symbols of at least one resource partition for the uplink transmissions from the radio unit, decoding the equalized modulation symbols and reconstructing modulation symbols for at least one resource partition for the uplink transmissions based on the decoded modulation symbols, sending the reconstructed modulation symbols to the radio unit for interference cancellation, and receiving interference-cancelled equalized modulation symbols of at least one other resource partition for the uplink transmissions from the RU.

Another example, (e.g., example 16) relates to a previously described example (e.g., example 15), further comprising sending, to the RU, at least one of an interference cancellation mode of operation information, or information used for DMRS-based channel estimation.

Another example, (e.g., example 17) relates to a previously described example (e.g., example 16), wherein the interference cancellation mode of operation information includes at least one of the number of iterations for the interference cancellation in a slot, an interference cancellation option including soft-symbol cancellation or hard-symbol cancellation, or a resource partition that corresponds to a successfully decoded codeword.

Another example, (e.g., example 18) relates to a previously described example (e.g., any one of examples 16-17), wherein the information used for DMRS-based channel estimation includes at least one of mapping physical resource blocks and layers to UEs, or UE specific parameters of time-offset, frequency-offset, delay spread, and/or Doppler spread.

Another example, (e.g., example 19) relates to a previously described example (e.g., any one of examples 15-18), wherein the DMRS configuration information includes at least one of DMRS port number, DMRS configuration type, DMRS symbol positions, or indication of whether transform precoding is enabled or disabled.

Another example, (e.g., example 20) relates to a previously described example (e.g., any one of examples 15-19), further comprising receiving, from the RU, at least one of interference cancellation capability of the radio unit, or UE-specific parameters of time-offset, frequency-offset, delay spread, and/or Doppler spread.

Another example (e.g., example 21) relates to a method for a radio access network. The method may include receiving, from a DU, DMRS configuration information and information regarding resource partition of scheduled resources for uplink transmissions from at least one UE in a slot, receiving uplink transmissions from one or more UEs, sending equalized modulation symbols of at least one resource partition of the uplink transmissions to the distributed unit, receiving reconstructed modulation symbols for at least one resource partition for the uplink transmissions from the distributed unit, performing interference cancellation on the equalized modulation symbols of the uplink transmissions based on the reconstructed modulation symbols, and sending interference-cancelled equalized modulation symbols of at least one other resource partition for the uplink transmissions to the distributed unit.

Another example, (e.g., example 22) relates to a previously described example (e.g., example 21), further comprising receiving from the DU at least one of interference cancellation mode of operation information, or information used for DMRS-based channel estimation.

Another example, (e.g., example 23) relates to a previously described example (e.g., example 22), wherein the interference cancellation mode of operation information includes at least one of the number of iterations for the interference cancellation in a slot, an interference cancellation option including soft-symbol cancellation or hard-symbol cancellation, or a resource partition that corresponds to a codeword successfully decoded by the distributed unit.

Another example, (e.g., example 24) relates to a previously described example (e.g., any one of examples 22-23), wherein the information used for DMRS-based channel estimation includes at least one of mapping physical resource blocks and layers to UEs, or UE specific parameters of time-offset, frequency-offset, delay spread, and/or Doppler spread.

Another example, (e.g., example 25) relates to a previously described example (e.g., any one of examples 21-24), wherein the DMRS configuration information includes at least one of DMRS port number, DMRS configuration type, DMRS symbol positions, or indication of whether transform precoding is enabled or disabled.

Another example, (e.g., example 26) relates to a previously described example (e.g., any one of examples 21-25), further comprising sending to the DU at least one of interference cancellation capability of the apparatus, or UE-specific parameters of time-offset, frequency-offset, delay spread, and/or Doppler spread.

Another example, (e.g., example 27) relates to a previously described example (e.g., any one of examples 21-26), wherein receiving the reconstructed modulation symbols from the DU for interference cancellation and sending interference-cancelled equalized modulation symbols of the uplink transmissions to the distributed unit are performed in multiple iterations.

Another example, (e.g., example 28) relates to a machine-readable medium including code, when executed, to cause a machine to perform the method as in any one of examples 15-27.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F) PLAs) or (field) programmable gate arrays ((F) PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions,-processes,-operations or-steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that-although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. An apparatus, comprising:
a communication circuitry configured to transmit and receive a signal to and from a radio unit (RU); and
a processing circuitry configured to:
provide, to the RU via the communication circuitry, demodulation reference signal (DMRS) configuration information and information regarding resource partition of scheduled resources for uplink transmissions from one or more user equipments (UEs) in a slot;
receive equalized modulation symbols of at least one resource partition for the uplink transmissions from the RU;
decode the equalized modulation symbols and reconstruct modulation symbols for at least one resource partition based on the decoded modulation symbols;
send the reconstructed modulation symbols to the RU for interference cancellation; and
receive interference-cancelled equalized modulation symbols of at least one other resource partition for the uplink transmissions from the RU.

2. The apparatus of claim 1, wherein the processing circuitry is configured to send, to the RU, at least one of interference cancellation mode of operation information or information used for DMRS-based channel estimation.

3. The apparatus of claim 2, wherein the interference cancellation mode of operation information includes at least one of the number of iterations for the interference cancellation in a slot, an interference cancellation option including soft-symbol cancellation or hard-symbol cancellation, or a resource partition that corresponds to a desired decoded codeword.

4. The apparatus of claim 2, wherein the information used for DMRS-based channel estimation includes at least one of mapping physical resource blocks and layers to UEs, or UE specific parameters of time-offset, frequency-offset, delay spread, and/or Doppler spread.

5. The apparatus of claim 1, wherein the DMRS configuration information includes at least one of DMRS port number, DMRS configuration type, DMRS symbol positions, or indication of whether transform precoding is enabled or disabled.

6. The apparatus of claim 1, wherein the processing circuitry is configured to receive, from the RU, at least one of interference cancellation capability of the RU, or UE-specific parameters of time-offset, frequency-offset, delay spread, and/or Doppler spread.

7. The apparatus of claim 1, wherein the processing circuitry is configured to send the reconstructed modulation symbols to the RU for interference cancellation and receive interference-cancelled equalized modulation symbols from the RU in multiple iterations.

8. An apparatus, comprising:
a communication circuitry configured to transmit and receive a signal to and from a distributed unit (DU); and
a processing circuitry configured to:
receive, from the DU via the communication circuitry, demodulation reference signal (DMRS) configuration information and information regarding resource partition of scheduled resources for uplink transmissions from at least one user equipment (UE) in a slot;
receive uplink transmissions from one or more UEs;
send equalized modulation symbols of at least one resource partition of the uplink transmissions to the DU;
receive reconstructed modulation symbols for at least one resource partition for the uplink transmissions from the DU;
perform interference cancellation on the equalized modulation symbols of the uplink transmissions based on the reconstructed modulation symbols; and
send interference-cancelled equalized modulation symbols of at least one other resource partition for the uplink transmissions to the DU.

9. The apparatus of claim 8, wherein the processing circuitry is configured to receive from the DU at least one of interference cancellation mode of operation information, or information used for DMRS-based channel estimation.

10. The apparatus of claim 9, wherein the interference cancellation mode of operation information includes at least one of the number of iterations for the interference cancellation in a slot, an interference cancellation option including soft-symbol cancellation or hard-symbol cancellation, or a resource partition that corresponds to a codeword successfully decoded by the DU.

11. The apparatus of claim 9, wherein the information used for DMRS-based channel estimation includes at least one of mapping physical resource blocks and layers to UEs, or UE specific parameters of time-offset, frequency-offset, delay spread, and/or Doppler spread.

12. The apparatus of claim 8, wherein the DMRS configuration information includes at least one of DMRS port number, DMRS configuration type, DMRS symbol positions, or indication of whether transform precoding is enabled or disabled.

13. The apparatus of claim 8, wherein the processing circuitry is configured to send to the DU at least one of interference cancellation capability of the apparatus, or UE-specific parameters of time-offset, frequency-offset, delay spread, and/or Doppler spread.

14. The apparatus of claim 8, wherein the processing circuitry is configured to receive the reconstructed modulation symbols from the DU for interference cancellation and send interference-cancelled equalized modulation symbols of the uplink transmissions to the DU in multiple iterations.

15. A method, comprising:
providing, to a radio unit, demodulation reference signal (DMRS) configuration information and information regarding resource partition of scheduled resources for uplink transmissions from at least one user equipment (UE) in a slot;
receiving equalized modulation symbols of at least one resource partition for the uplink transmissions from the radio unit;
decoding the equalized modulation symbols and reconstructing modulation symbols for at least one resource partition for the uplink transmissions based on the decoded modulation symbols;
sending the reconstructed modulation symbols to the radio unit for interference cancellation; and
receiving interference-cancelled equalized modulation symbols of at least one other resource partition for the uplink transmissions from the radio unit.

16. The method of claim 15, further comprising:
sending, to the radio unit, at least one of an interference cancellation mode of operation information, or information used for DMRS-based channel estimation.

17. The method of claim 16, wherein the interference cancellation mode of operation information includes at least one of the number of iterations for the interference cancellation in a slot, an interference cancellation option including soft-symbol cancellation or hard-symbol cancellation, or a resource partition that corresponds to a desired decoded codeword.

18. The method of claim 16, wherein the information used for DMRS-based channel estimation includes at least one of mapping physical resource blocks and layers to UEs, or UE specific parameters of time-offset, frequency-offset, delay spread, and/or Doppler spread.

19. The method of claim 15, wherein the DMRS configuration information includes at least one of DMRS port number, DMRS configuration type, DMRS symbol positions, or indication of whether transform precoding is enabled or disabled.

20. The method of claim 15, further comprising:
receiving, from the radio unit, at least one of interference cancellation capability of the radio unit, or UE-specific parameters of time-offset, frequency-offset, delay spread, and/or Doppler spread.
